(19) United States
(12) Patent Application Publication
(10) Pub. No.: US 2015/0193658 A1
(43) Pub. Date: Jul. 9, 2015

(54) Enhanced Photo And Video Taking Using Gaze Tracking

(71) Applicants: Quentin Simon Charles Miller, Sammamish, WA (US); Stephen G. Latta, Seattle, WA (US); Drew Steedly, Redmond, WA (US)

(72) Inventors: Quentin Simon Charles Miller, Sammamish, WA (US); Stephen G. Latta, Seattle, WA (US); Drew Steedly, Redmond, WA (US)

(21) Appl. No.: 14/151,492

(22) Filed: Jan. 9, 2014

(51) Int. Cl. G06K 9/00; H04N 5/232

(52) U.S. Cl. CPC G06K 9/00604; H04N 5/23293; H04N 5/23296

(57) ABSTRACT

When a user takes a photograph or video of a scene with an image capture device, such as computing device having a camera, a point of interest in the scene is determined. The computing device includes an eye tracker to output a gaze vector of a user's eye viewing the scene through a view finder that indicates a point of interest in the scene. Selected operation may then be performed based on the determined point of interest in the scene. An amount of exposure used to capture the image may be selected based on the point of interest. Zooming or adjusting the field of view through a view finder may be anchored at the point of interest, and the image through the view finder may be zoomed about the point of interest, before the image is captured. Image enhancing effects may be performed about the point of interest.

### BACKGROUND

Different types of computing devices may capture or take an electronic image of a subject or object. For example, a user may use a camera or video recorder to take a photograph or video of a person or scene. Other computing devices may also capture images, such as electronic billboards, personal computers, laptops, notebooks, tablets, telephones or wearable computing devices.

Captured images may be stored locally in the computing device, or transferred to a remote computing device for storage. Similarly, images may be retrieved and viewed by the computing device that took the image, or alternatively the image may be viewed on a display of a different computing device at a remote site.

### SUMMARY

When a user takes a photograph or video of a scene with an image capture device, such as computing device having a camera, a point of interest in the scene is determined. The computing device includes an eye tracker to output a gaze vector of a user's eye viewing the scene through a view finder that indicates a point of interest in the scene.

Selected operation may then be performed based on the determined point of interest in the scene. For example, an amount of exposure used to capture the image may be selected based on the point of interest. Zooming or adjusting the field of view through a view finder may be anchored at the point of interest, and the image through the view finder may be zoomed automatically or manually (or gestured) by the user about the point of interest, before the image is captured. Image enhancing effects may be performed about the point of interest, such as enhancing blurred lines of shapes at or near the point of interest.

A method embodiment of obtaining an image comprises receiving information that indicates a direction of a gaze in a view finder. A determination of a point of interest in the view finder is made based on the information that indicates the direction of the gaze. A determination of an amount of exposure to capture the image is also made based on the point of interest. A field of view is adjusted in the view finder about the point of interest and the imaged is captured with the determined amount of exposure and field of view.

An apparatus embodiment comprises a view finder and at least one sensor to capture an image in the view finder in response to a first signal that indicates an amount of exposure and a second signal that indicates a point to zoom from in the view finder. At least one eye tracker outputs a gaze vector that indicates a direction of a gaze in the view finder. At least one processor executes processor readable instructions stored in processor readable memory to: 1) receive the gaze vector; 2) determine a point of interest in the view finder based on the gaze vector; 3) determine an amount of exposure based on the point of interest; 4) determine the point to zoom from in the view finder; and 5) output the first signal that indicates the amount of exposure and the second signal that indicates the point to zoom from in the view finder. In an embodiment, the point to zoom from is the point of interest.

In another embodiment, one or more processor readable memories include instructions which when executed cause one or more processors to perform a method for capturing an image by a camera. The method comprises receiving a gaze vector from an eye tracker and determining a point of interest in a view finder of the camera based on the gaze vector. A point of interest is determined in a view finder of the camera based on the gaze vector. An amount of exposure based on the point of interest is determined A point of zoom from the view finder is determined A first signal that indicates the amount of exposure to the camera is output along with a second signal that indicates the point to zoom from in the view finder to the camera. A third signal may be output that indicates an amount of zoom around the point of interest. The point to zoom from is the point of interest in an embodiment.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a high-level block diagram of an exemplary system architecture.

FIG. 2 is a high-level block diagram of an exemplary software architecture.

FIG. 3A illustrates an exemplary scene.

FIG. 3B illustrates an exemplary image capture device used to take an image of the scene illustrated in FIG. 3A.

FIG. 3C illustrates an exemplary image capture device having a determined exposure and amount of zoom for taking an image of the scene illustrated in FIG. 3A

FIGS. 4A-B illustrate exemplary glasses having an image capture device used in exemplary networks.

FIGS. 5A-B illustrate side and top portions of exemplary glasses.

FIGS. 6-8 are flow charts of exemplary methods to capture an image.

FIG. 9 illustrates an exemplary computing device.

### DETAILED DESCRIPTION

When a user takes a photograph or video of a scene with an image capture device, such as computing device having a camera, a point of interest in the scene is determined. The computing device includes an eye tracker to output a gaze vector of a user's eye viewing the scene through a view finder that indicates a point of interest in the scene.

Selected operation may then be performed based on the determined point of interest in the scene. For example, an amount of exposure used to capture the image may be selected based on the point of interest. Zooming or adjusting the field of view through a view finder may be anchored at the point of interest, and the image through the view finder may be zoomed automatically or manually (or gestured) by the user about the point of interest, before the image is captured. Image enhancing effects may be performed about the point of interest, such as enhancing blurred lines of shapes at or near the point of interest.

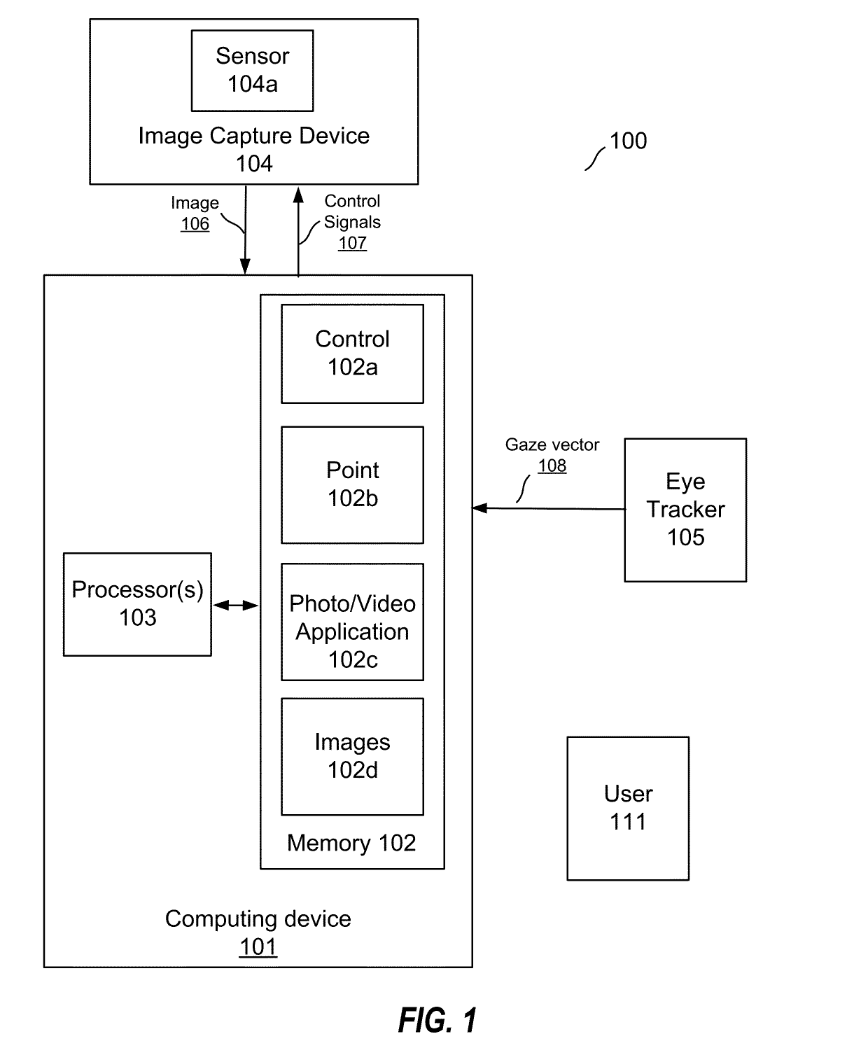

FIG. 1 is a high-level block diagram of an apparatus (or system) 100 for capturing an image, such as a photograph or video. In particular, apparatus 100 uses eye gazing information of a user to determine a point of interest when capturing an image of a scene. In an embodiment, apparatus 100 includes an image capture device 104 (such as a camera), computing device 101 and eye tracker 105.

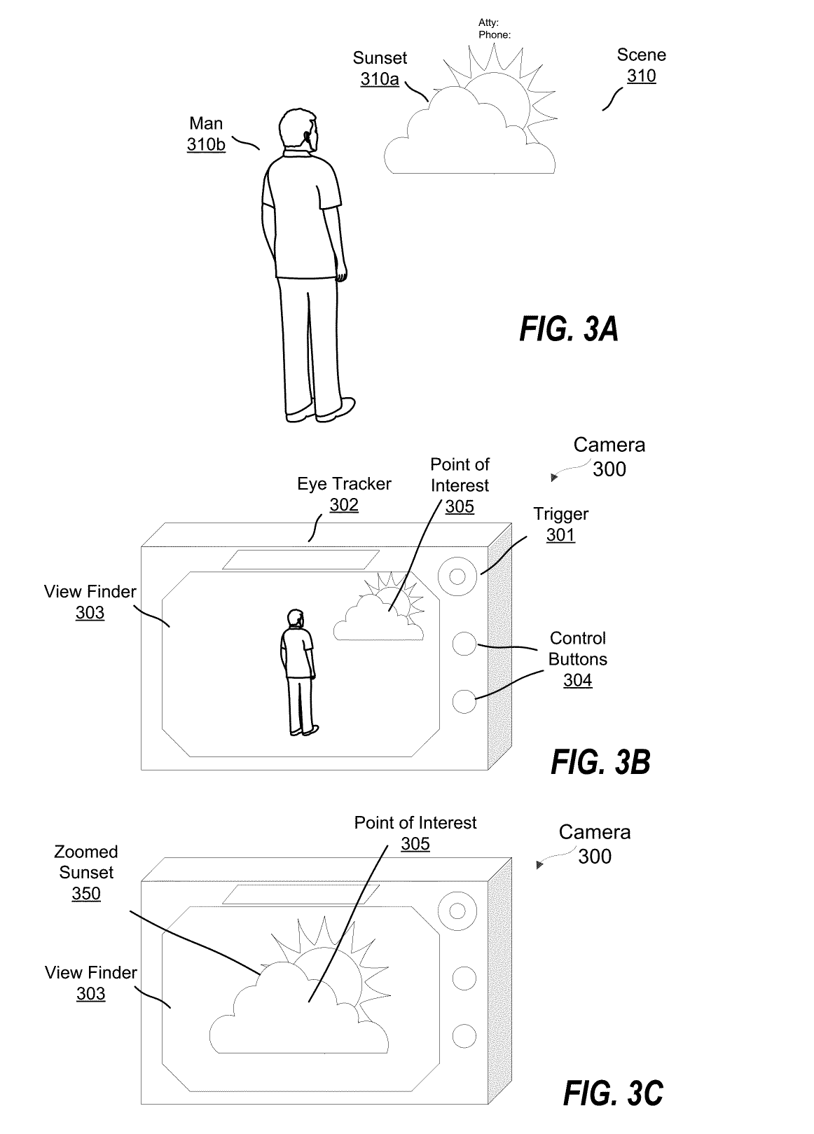

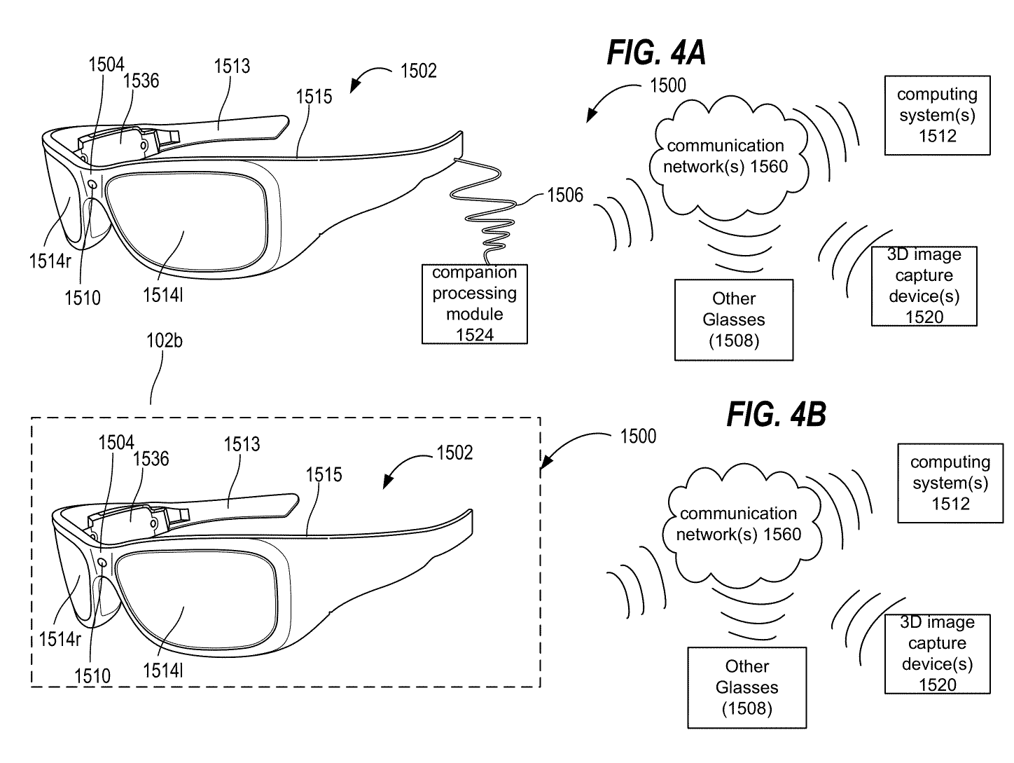

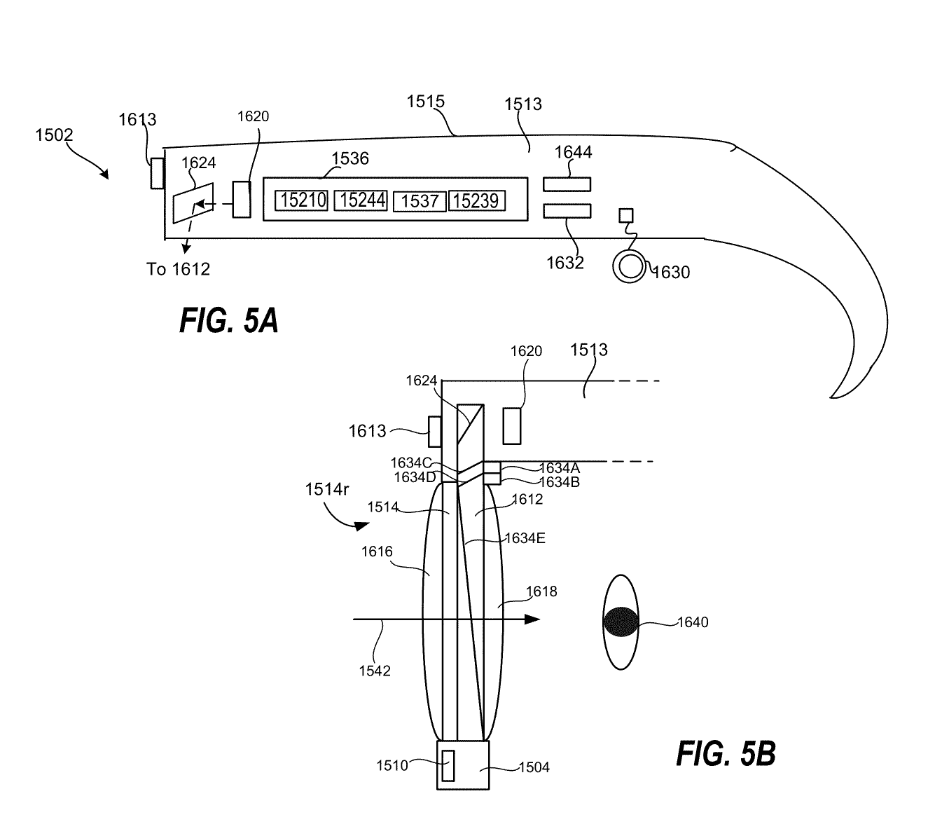

In an embodiment, image capture device 104 takes or captures an image 106 after eye tracker 105 provides information that indicates a point of interest of a user 111 (gaze vector 108) in a scene shown in a view finder (such as view finder 303 shown in FIG. 3B) of the image capture device 104. In an embodiment, image capture device 104 includes an electronic sensor 104a to capture the image 106. Image capture device 104 transfers an image 106 to computing device 101 after computing device 101 transfers one or more control signals to image capture device 104 in an embodiment. Control signals 107 are output in response to computing device 101 receiving a gaze vector 108 from eye tracker 105.

Eye tracker 105 outputs information that indicates a point of interest of a user 111 in a scene to be captured by image capture device 104. In an embodiment, eye tracker 105 outputs a gaze vector 108 that indicates a point of interest of a scene in a view finder of image capture device 104. In an embodiment, eye tracker 105 is positioned near a view finder of image capture device 104.

Computing device 101 includes a processor(s) 103 that executes (or reads) processor readable instructions stored in memory 102 to output control signals used to capture an image. In an embodiment, memory 102 is processor readable memory that stores software components, such as control 102a, point 102b, photo/video application 102c and images 102d.

In an embodiment, images received from image capture device 104, such as image 106, are stored in images 102d. In an alternate embodiment, images may be stored at a remote computing device.

In an embodiment, control 102a, at least in part, controls computing device 101. In an embodiment, control 102a outputs control signals 107 and receives one or more gaze vector 108. In an embodiment, control 102a is an operating system of computing device 101.

In an embodiment, point 102b receives gaze vector 108, by way of control 102a, and determines a point of interest of a user 111 viewing a scene through a view finder. For example, a user may have a point of interest 305 that corresponds to a sunset in view finder 303 as illustrated in FIG. 3B. In embodiment, point 102b receives multiple gaze vector(s) 108 before determining a point of interest of user 111. Point 102b then outputs point of interest information to photo/video application 102c based on gaze vector 108.

Photo/video application 102c is responsible for determining the amount of exposure and adjusting a view angle (or amount of zoom) based on the point of interest of a user viewing a scene in a view finder of an image capture device. Photo/video application 102c is also responsible for determining an anchor point or point in the view finder to adjust a view angle (or apply an amount of zoom). Photo/video application 102c also provides image enhancing effects to images based on the point of interest in an embodiment.

In an embodiment, image capture device 104 is included or packaged with computing device 101. In another embodiment, image capture device 104 and eye tracker 105 are packaged separately from computing device 101.

In an embodiment, image capture device 104, computing device 101 and eye tracker 105 are package and included in a single device. For example, image capture device 104, computing device 101 and eye tracker 105 may be included in eye glasses (glasses), digital camera, cellular telephone, computer, notebook computer, laptop computer or tablet.

Computing device 101, image capture device 104 and eye tracker 105 may transfer information, such as images, control and gaze vector information, by wired or wireless connections. Computing device 101, image capture device 104 and eye tracker 105 may communicate by way of a network, such as a Local Area Network (LAN), Wide Area Network (WAN) and/or the Internet.

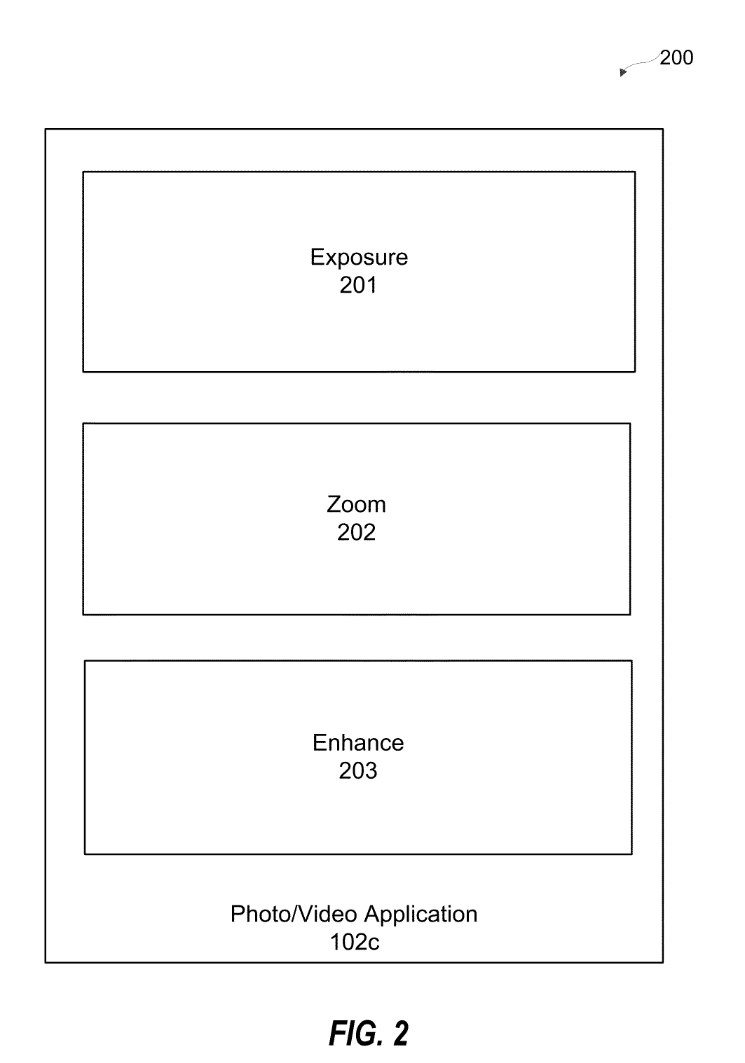

FIG. 2 is a high-level block diagram of an exemplary software architecture 200 of photo/video application 102c.

In an embodiment, photo/video application 102c includes at least one software component. In embodiments, a software component may include a computer (or software) program, object, function, subroutine, method, instance, script and/or processor readable instructions, or portion thereof, singly or in combination. One or more exemplary functions that may be performed by the various software components are described herein. In alternate embodiments, more or less software components and/or functions of the software components described herein may be used.

In an embodiment, photo/video application 102c includes software components such as exposure 201, zoom 202 and enhance 203.

Exposure 201, in an embodiment, is responsible for determining an amount of exposure based on the point of interest of a user. In an embodiment, determining the amount of exposure includes determining a quantity of light to reach an electronic sensor 104a used to capture the image 106, as illustrated in FIGS. 1 and 3A-C. In an embodiment, the amount of exposure is measured in lux seconds.

Zoom 202, in an embodiment, is responsible for adjusting a viewing angle (or zooming in or out) based on the point of interest of a user. For example, zoom 202 provides a zoomed sunset 350 in view finder 303 after a determination is made (using eye tracker 302) that a user has sunset 310a as a point of interest 305 in scene 310, as shown in FIGS. 3A-C. In an embodiment, zoom 202 determines an anchor point (or point to zoom from) to adjust a viewing angle or apply an amount of zoom. In an embodiment, an anchor point or point from which an amount of zoom is applied is the point of interest.

Zoom 202 also determines the amount of zoom to apply (positive or negative). In an embodiment, zoom 202 determines the amount of zoom based on the scene in a view finder. In another embodiment, zoom 202 applies a predetermined amount of zoom, such as 2×, 3×, 4× . . . In an embodiment, the predetermined amount of zoom may be selected by a user. In another embodiment, an amount of zoom is applied based on a user input or gesture at the time of taking the image.

Enhance 203, in an embodiment, is responsible for providing image enhancing effects to images, such as image 106 in FIG. 1. In an embodiment, enhance 203 sharpens lines of shapes about the point of interest of an image that may be blurred due to an application of an amount of zoom. In an embodiment, enhance 203 may apply image enhancing effects to images stored in images 102d or retrieved from a remote location.

In alternate embodiments, enhance 203 includes other types of image enhancing effects software components to enhance an image. For example, enhance 203 may include noise reduction, cropping, color change, orientation, contrast and brightness software components to apply respective image enhancing effects to an image, such as image 106.

FIG. 3A illustrates a scene 310 having a man 310b and sunset 310a. In an embodiment, a user may use an image capture device, such as camera 300 shown in FIG. 3B, to capture an image of scene 310.

FIG. 3B illustrates a camera 300 to capture an image of a scene 310 as seen by a user in view finder 303 of camera 300. In an embodiment, camera 300 includes image capture device 104, computing device 101 and eye tracker 105. A user may capture an image (a photograph or video) seen in view finder 303 by pressing a trigger 301. Controls buttons 304 also include buttons for operating camera 300. For example, control buttons 304 may include a button to manually zoom in or out as well as set an exposure. In an alternate embodiment, trigger 301 and buttons 304 are included in a touch screen that also may be included in view finder 303. In an embodiment, an eye tracker 302, corresponding to eye tracker 105 shown in FIG. 1, is disposed on camera 300 to output a gaze vector that indicates that a user has the sunset 310a as a point of interest 305.

FIG. 3C illustrates zoomed sunset 350 that is a zoomed in version of sunset 310a (or an adjusted view angle of sunset 310a) in view finder 303 that has an exposure determined for zoomed sunset 350. In an embodiment, photo/video application 102c determines an amount of zoom (such as 2×, 3× . . . ), an anchor point to zoom from and determines an amount of exposure for a point of interest 305, an in particular sunset 310a.

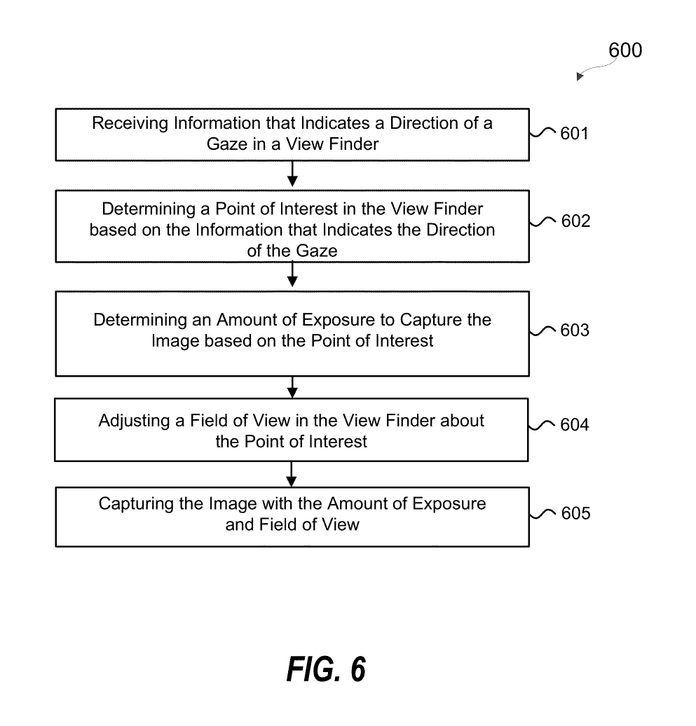

FIG. 4A illustrates an apparatus 1500 that includes glasses (or eyeglasses) 1502 that includes a camera and eye tracking system as described herein. Apparatus 1500 includes glasses 1502 in which communicates with companion processing module 1504 via a wire 1506 in this example or wirelessly in other examples. In an embodiment, companion processing module 1524 corresponds to computing device 101 shown in FIG. 1. In this embodiment, glasses 1502 includes a frame 1515 with temple arms 1513 and 1515 as well as nose bridge 1504.

In an embodiment, glasses 1502 includes a display optical system 1514, 1514r and 1514l, for each eye in which image data is projected into a user's eye to generate a display of the image data while a user also sees through the display optical systems 1514 for an actual direct view of the real world.

Each display optical system 1514 is also referred to as a see-through display, and the two display optical systems 1514 together may also be referred to as a see-through, meaning optical see-through display 1514.

Frame 1515 provides a support structure for holding elements of the apparatus in place as well as a conduit for electrical connections. In this embodiment, frame 1515 provides a convenient eyeglass frame as support for the elements of the apparatus discussed further below. The frame 1515 includes a nose bridge 1504 with a microphone 1510 for recording sounds and transmitting audio data to control circuitry 1536. In this example, the temple arm 1513 is illustrated as including control circuitry 1536 for the glasses 1502.

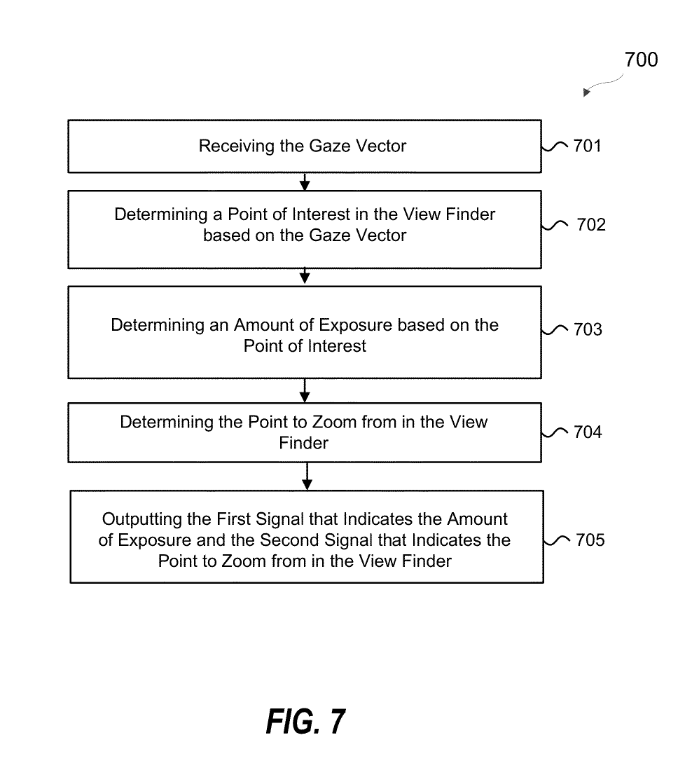

As illustrated in FIGS. 5A and 5B are outward facing image capture devices 1613, e.g. cameras, for recording digital image data such as still images (or photographs), videos or both, and transmitting the visual recordings to the control circuitry 1536 which may in turn send the captured image data to the companion processing module 1524 which may also send the data to one or more computer systems 1512 or to another personal A/V apparatus over one or more communication networks 1560.

In another embodiment, an image generation unit 1620 is included on each temple arm 1513.

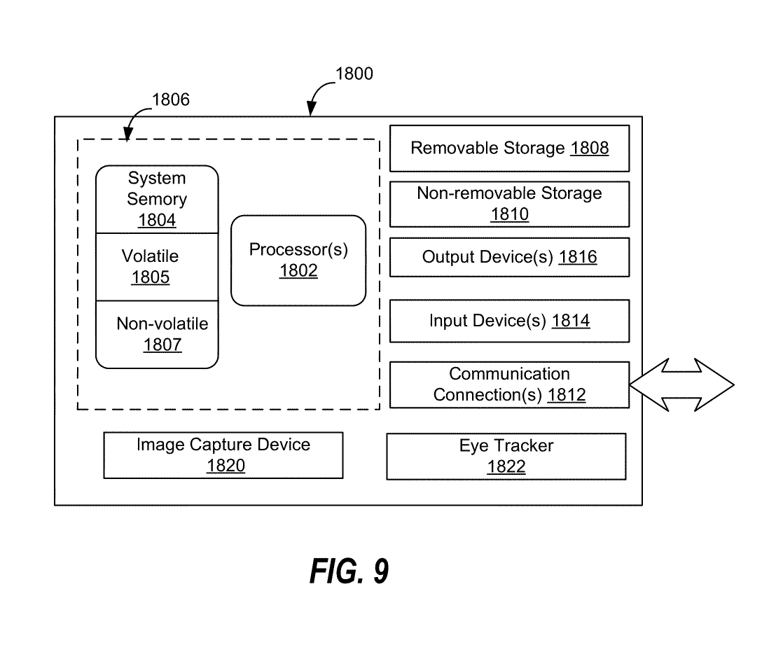

As illustrated in FIGS. 4B, glasses 1502 (or companion processing module 1524) may communicate wired and/or wirelessly (e.g., WiFi, Bluetooth, infrared, an infrared personal area network, RFID transmission, WUSB, cellular, 3G, 4G or other wireless communication means) over one or more communication networks 1560 to one or more computer systems 1512 whether located nearby or at a remote location, other glasses 1508 in a location or environment. An example of some hardware components of a computer system 1512 is also shown in FIG. 9 in an embodiment. The scale and number of components may vary considerably for different embodiments of the computer system 1512.

An application may be executing on a computer system 1512 which interacts with or performs processing for an application executing on one or more processors in the apparatus 1500. For example, a 3D mapping application may be executing on the one or more computers systems 1512 in apparatus 1500.

In the illustrated embodiments of FIGS. 4A and 4B, the one or more computer system 1512 and the apparatus 1500 also have network access to one or more 3D image capture devices 1520 which may be, for example one or more cameras that visually monitor one or more users and the surrounding space such that gestures and movements performed by the one or more users, as well as the structure of the surrounding space including surfaces and objects, may be captured, analyzed, and tracked. Image data, and depth data if captured, of the one or more 3D capture devices 1520 may supplement data captured by one or more image capture devices 1613 on the glasses 1502 of the apparatus 1500.

FIG. 5A is a side view of an eyeglass temple arm 1513 of a frame of glasses 1502 providing support for hardware and software components. At the front of frame 1515 is depicted one of at least two physical environment facing image capture devices 1613, e.g. cameras that can capture image data like video and still images, typically in color, of the real world or a scene. In some examples, the image capture devices 1613 may also be depth sensitive, for example, they may be depth sensitive cameras which transmit and detect infrared light from which depth data may be determined.

Control circuitry 1536 provide various electronics that support the other components of glasses 1502. In this example, the right temple arm 1513 includes control circuitry 1536 for glasses 1502 which includes a processor 15210, a memory 15244 accessible to the processor 15210 for storing processor readable instructions and data, a wireless interface 1537 communicatively coupled to the processor 15210, and a power supply 15239 providing power for the components of the control circuitry 1536 and the other components of glasses 1502 like the cameras 1613, the microphone 1510. The processor 15210 may comprise one or more processors that may include a controller, CPU, GPU and/or FPGA as well as multiple processor cores.

In embodiments, glasses 1502 may include other sensors. Inside, or mounted to temple arm 1502, are an earphone of a set of earphones 1630, an inertial sensing unit 1632 including one or more inertial sensors, and a location sensing unit 1644 including one or more location or proximity sensors, some examples of which are a GPS transceiver, an IR transceiver, or a radio frequency transceiver for processing RFID data.

In an embodiment, each of the devices that processes an analog signal in its operation include control circuitry which interfaces digitally with the digital processor 15210 and memory 15244 and which produces or converts analog signals, or both produces and converts analog signals, for its respective device. Some examples of devices which process analog signals are the sensing units 1644, 1632, and earphones 1630 as well as the microphone 1510, image capture devices 1613 and a respective IR illuminator 1634A, and a respective IR detector or camera 1634B for each eye's display optical system 1514l, 1514r discussed herein.

In still a further embodiment, mounted to or inside temple arm 1515 is an image source or image generation unit 1620 which produces visible light representing images. The image generation unit 1620 can display a virtual object to appear at a designated depth location in the display field of view to provide a realistic, in-focus three dimensional display of a virtual object which can interact with one or more real objects.

In some embodiments, the image generation unit 1620 includes a microdisplay for projecting images of one or more virtual objects and coupling optics like a lens system for directing images from the microdisplay to a reflecting surface or element 1624. The reflecting surface or element 1624 directs the light from the image generation unit 1620 into a light guide optical element 1612, which directs the light representing the image into the user's eye.

FIG. 5B is a top view of an embodiment of one side of glasses 1502 including a display optical system 1514. A portion of the frame 1515 of glasses 1502 will surround a display optical system 1514 for providing support and making electrical connections. In order to show the components of the display optical system 1514, in this case 1514r for the right eye system, in glasses 1502, a portion of the frame 1515 surrounding the display optical system is not depicted.

In the illustrated embodiment, the display optical system 1514r is an integrated eye tracking and display system. The system embodiment includes an opacity filter 1514 for enhancing contrast of virtual imagery, which is behind and aligned with optional see-through lens 1616 in this example, light guide optical element 1612 for projecting image data from the image generation unit 1620 is behind and aligned with opacity filter 1514, and optional see-through lens 1618 is behind and aligned with light guide optical element 1612.

Light guide optical element 1612 transmits light from image generation unit 1620 to the eye 1640 of a user wearing glasses 1502, such as user 111 shown in FIG. 1. Light guide optical element 1612 also allows light from in front of glasses 1502 to be received through light guide optical element 1612 by eye 1640, as depicted by an arrow representing an optical axis 1542 of the display optical system 1514r, thereby allowing a user to have an actual direct view of the space in front of glasses 1502 in addition to receiving a virtual image from image generation unit 1620. Thus, the walls of light guide optical element 1612 are see-through. In this embodiment, light guide optical element 1612 is a planar waveguide. A representative reflecting element 1634E represents the one or more optical elements like mirrors, gratings, and other optical elements which direct visible light representing an image from the planar waveguide towards the eye 1640.

Infrared illumination and reflections, also traverse the planar waveguide for an eye tracking system (or eye tracker) 1634 for tracking the position and movement of the eye 1640, typically the user's pupil. Eye movements may also include blinks. The tracked eye data may be used for applications such as gaze detection, blink command detection and gathering biometric information indicating a personal state of being for the user. In an embodiment, eye tracker 1634 outputs a gaze vector that indicates a point of interest in a scene that will be photographed or videoed by image capture device 1613. In an embodiment, a lens of display optical system 1514r is used as a view finder for taking photographs or videos.

The eye tracking system 1634 comprises an eye tracking IR illumination source 1634A (an infrared light emitting diode (LED) or a laser (e.g. VCSEL)) and an eye tracking IR sensor 1634B (e.g. IR camera, arrangement of IR photo detectors, or an IR position sensitive detector (PSD) for tracking glint positions). In this embodiment, representative reflecting element 1634E also implements bidirectional IR filtering which directs IR illumination towards the eye 1640, preferably centered about the optical axis 1542 and receives IR reflections from the eye 1640. A wavelength selective filter 1634C passes through visible spectrum light from the reflecting surface or element 1624 and directs the infrared wavelength illumination from the eye tracking illumination source 1634A into the planar waveguide. Wavelength selective filter 1634D passes the visible light and the infrared illumination in an optical path direction heading towards the nose bridge 1504. Wavelength selective filter 1634D directs infrared radiation from the waveguide including infrared reflections of the eye 1640, preferably including reflections captured about the optical axis 1542, out of the light guide optical element 1612 embodied as a waveguide to the IR sensor 1634B.

Opacity filter 1514, which is aligned with light guide optical element 1612, selectively blocks natural light from passing through light guide optical element 1612 for enhancing contrast of virtual imagery. The opacity filter 1514 assists the image of a virtual object to appear more realistic and represent a full range of colors and intensities. In this embodiment, electrical control circuitry for the opacity filter 1514, not shown, receives instructions from the control circuitry 1536 via electrical connections routed through the frame.

Again, FIGS. 5A and 5B show half of glasses 1502. For the illustrated embodiment, a full glasses 1502 may include another display optical system 1514 and components as described herein.

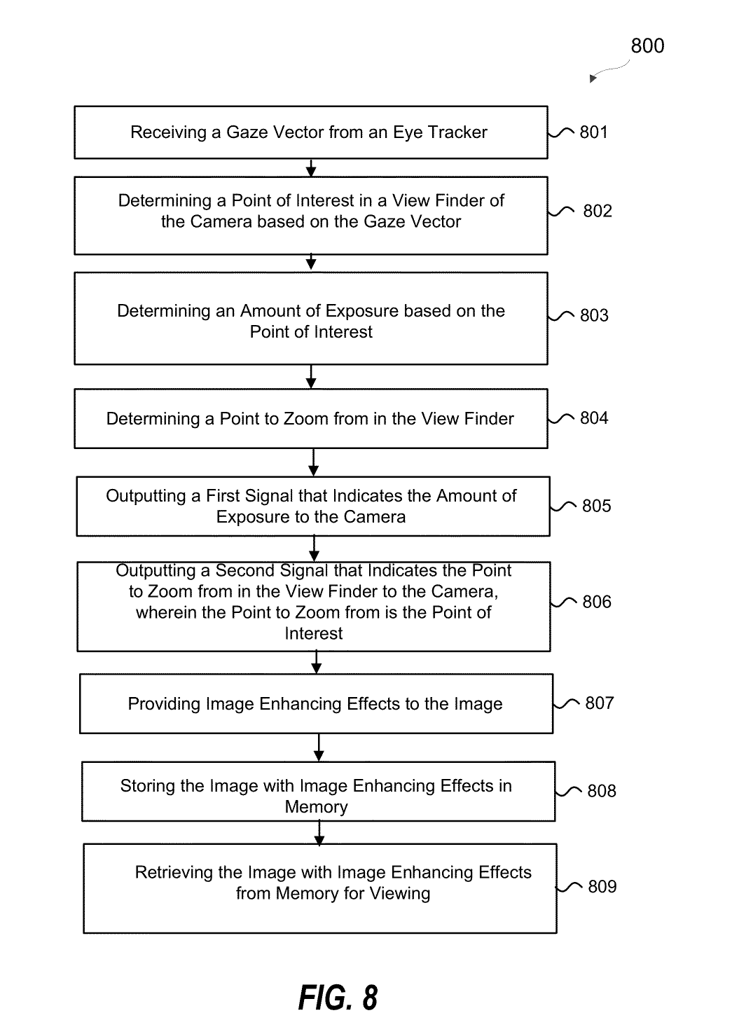

FIGS. 6-8 are flow charts illustrating exemplary methods of capturing an image. In embodiments, blocks illustrated in FIGS. 6-8 represent the operation of hardware (e.g., processor, memory, circuits), software (e.g., operating system, applications, drivers, machine/processor readable instructions), or a user, singly or in combination. As one of ordinary skill in the art would understand, embodiments may include less or more blocks shown.

FIG. 6 is a flow chart illustrating method 600 for capturing an image with a determined amount of exposure and field of view based on a point of interest. In an embodiment method 600 is performed by computing device 101 and at least some of the software components shown in FIG. 1.

Block 601 illustrates receiving information that indicates a direction of a gaze in a view finder. In an embodiment, computing device 101 receives a gaze vector 108 from eye tracker 105. In an embodiment, a gaze vector 108 indicates the point of interest of user 111 in a view finder of an image capture device 104.

Block 602 illustrates determining a point of interest in the view finder based on the information that indicates the direction of the gaze. In an embodiment, point 102b determines the point of interest based on the information that indicates a direction of a gaze, such as gaze vector 108, of a user.

Block 603 illustrates determining an amount of exposure to capture the image based on the point of interest. In an embodiment, determining the amount of exposure includes determining a quantity of light to reach a sensor 104a used to capture the image 106, as illustrated in FIGS. 1 and 3A-C. In an embodiment, the amount of exposure is measured in lux seconds.

Block 604 illustrates adjusting a field of view in the view finder about the point of interest. In an embodiment, adjusting a field of view includes zooming in or out an image on a view finder about the point of interest. In an embodiment, an image is zoomed a predetermined amount, such as 2×. In other embodiments, a user may manually or gesture zoom in or out.

Block 605 illustrates capturing the image with the amount of exposure and adjusted field of view. In an embodiment, image capture device 104 captures the image with the determined exposure and determined field of view. In an embodiment, image 106 is transferred to computing device 101 and stored in images 102d of memory 102 as illustrated in FIG. 1. An image may then be retrieved and viewed by computing device 101. In an embodiment, photo/video application 102c retrieves and renders a stored image.

FIG. 7 is a flow chart illustrating a method 700 for outputting information used in capturing an image.

Block 701 illustrates receiving the gaze vector, such as gaze vector 108 shown in FIG. 1.

Block 702 illustrates determining a point of interest in the view finder based on the gaze vector. In an embodiment, point 102b, stored in memory 102, determines the point of interest based on the gaze vector 108, of a user.

Block 703 illustrates determining an amount of exposure based on the point of interest. In an embodiment, determining the amount of exposure includes determining a quantity of light to reach a sensor as described herein.

Block 704 illustrates determining the point to zoom from in the view finder. In an embodiment, point 102b determines a point of interest as described herein. In an embodiment, a point of interest is used as the point to zoom from, or anchor, in the view finder for zooming in or out.

Block 705 illustrates outputting the first signal that indicates the amount of exposure and the second signal that indicates the point to zoom from in the view finder. In another embodiment, a third signal that indicates an amount of zoom around (or about) the point of interest is also output as illustrated by logic block 705 in an embodiment. An amount of zoom may be determined by photo/video application 102c, and in particular zoom 202 in an embodiment. The first and second signals (as well as third control signal in an embodiment) are included in control signals 107 from computing device 101 to image capture device 104 as illustrated in FIG. 1.

FIG. 8 is a flow chart illustrating a method 800 for outputting information used in capturing an image.

Block 801 illustrates receiving a gaze vector from an eye tracker.

Block 802 illustrates determining a point of interest in a view finder of the camera based on the gaze vector.

Block 803 illustrates determining an amount of exposure based on the point of interest.

Block 804 illustrates determining a point to zoom from in the view finder.

Block 805 illustrates outputting a first signal that indicates the amount of exposure to the camera.

Block 806 illustrates outputting a second signal that indicates the point to zoom from in the view finder to the camera. In an embodiment, the point to zoom from is the point of interest.

Block 807 illustrates providing image enhancing effects to the image. In an embodiment, enhance 203 enhances an image, such as image 106. In an embodiment, enhance 203 may include filters or other image processing software components or functions to sharpen blurry lines about the point of interest.

Block 808 illustrates storing the image with image enhancing effects in memory, such as memory 102 shown in FIG. 1.

Block 809 illustrates retrieving the image with image enhancing effects from memory for viewing by a user.

FIG. 9 is a block diagram of one embodiment of a computing device 1800 which may host at least some of the software components illustrated in FIGS. 1 and 2 (and corresponds to computing device 101 in an embodiment). In an embodiment, image capture device 1820 and eye tracker 1822 are included in computing device 1800. In embodiments, image capture device 1820 and eye tracker 1822 correspond to image capture device 104 and eye tracker 105 shown in FIG. 1. In an embodiment, computing device 1800 is a mobile device such as a cellular telephone, or tablet, having a camera. Eye tracker 105 may be included with computing device 1800 or may be external to computing device 1800, such as glasses as described herein.

In its most basic configuration, computing device 1800 typically includes one or more processor(s) 1802 including one or more CPUs and/or GPUs as well as one or more processor cores. Computing device 1800 also includes system memory 1804. Depending on the exact configuration and type of computing device, system memory 1804 may include volatile memory 1805 (such as RAM), non-volatile memory 1807 (such as ROM, flash memory, etc.) or some combination of the two. This most basic configuration is illustrated in FIG. 9 by dashed line 1806. Additionally, device 1800 may also have additional features/functionality. For example, device 1800 may also include additional storage (removable and/or non-removable) including, but not limited to, magnetic or optical discs or tape. Such additional storage is illustrated in FIG. 9 by removable storage 1808 and non-removable storage 1810.

Device 1800 may also contain communications connection(s) 1812 such as one or more network interfaces and transceivers that allow the device to communicate with other devices. Device 1800 may also have input device(s) 1814 such as keyboard, mouse, pen, voice input device, touch input device (touch screen), gesture input device, etc. Output device(s) 1816 such as a display, speakers, printer, etc. may also be included. These devices are well known in the art so they are not discussed at length here.

In an embodiment, a user may enter input to input device(s) 1814 by way of gesture, touch or voice. In an embodiment, input device(s) 1814 includes a natural user interface (NUI) to receive and translate voice and gesture inputs from a user. In an embodiment, input device(s) 1814 includes a touch screen and a microphone for receiving and translating a touch or voice, such as a voice command, of a user.

One or more processor(s) 1802, system memory 1804, volatile memory 1805 and non-volatile memory 1807 are interconnected via one or more buses. The details of the bus that is used in this implementation are not particularly relevant to understanding the subject matter of interest being discussed herein. However, it will be understood that such a bus might include one or more of serial and parallel buses, a memory bus, a peripheral bus, and a processor or local bus, using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

In an embodiment, one or more processor(s) 1802, volatile memory 1805 and non-volatile memory 1807 are integrated onto a system on a chip (SoC, a.k.a. SOC) is an integrated circuit (IC) that integrates electronic components and/or subsystems of a computing device or other electronic system into a single semiconductor substrate and/or single chip housed within a single package. For example, memory that was previously in a memory module subsystem in a personal computer (PC) may now be included in a SoC. Similarly, memory control logic may be included in a processor of a SoC rather than in a separately packaged memory controller.

As one of ordinary skill in the art would appreciate, other electronic components may be included in a SoC. A SoC may include digital, analog, mixed-signal, and/or radio frequency circuits—one or more on a single semiconductor substrate. A SoC may include oscillators, phase-locked loops, counter-timers, real-time timers, power-on reset generators, external interfaces (for example, Universal Serial Bus (USB), IEEE 1394 interface (FireWire), Ethernet, Universal Asynchronous Receiver/Transmitter (USART) and Serial Peripheral Bus (SPI)), analog interfaces, voltage regulators and/or power management circuits.

In alternate embodiments, a SoC may be replaced with a system in package (SiP) or package on package (PoP). In a SiP, multiple chips or semiconductor substrates are housed in a single package. In a SiP embodiment, processor cores would be on one semiconductor substrate and high performance memory would be on a second semiconductor substrate, both housed in a single package. In an embodiment, the first semiconductor substrate would be coupled to the second semiconductor substrate by wire bonding.

In a PoP embodiment, processor cores would be on one semiconductor die housed in a first package and high performance memory would be on a second semiconductor die housed in a second different package. The first and second packages could then be stacked with a standard interface to route signals between the packages, in particular the semiconductor dies. The stacked packages then may be coupled to a printed circuit board having memory additional memory as a component in an embodiment.

In embodiments, a processor includes at least one processor core that executes (or reads) processor (or machine) readable instructions stored in processor readable memory. An example of processor readable instructions may include control 102a, point 102b, photo/video application 102c and images 102d shown in FIG. 1. Processor cores may also include a controller, graphics-processing unit (GPU), digital signal processor (DSP) and/or a field programmable gate array (FPGA).

In embodiments, memory includes one or more arrays of memory cells on an integrated circuit. Types of volatile memory include, but are not limited to, dynamic random access memory (DRAM), molecular charge-based (ZettaCore) DRAM, floating-body DRAM and static random access memory (“SRAM”). Particular types of DRAM include double data rate SDRAM (“DDR”), or later generation SDRAM (e.g., “DDRn”).

Types of non-volatile memory include, but are not limited to, types of electrically erasable program read-only memory (“EEPROM”), FLASH (including NAND and NOR FLASH), ONO FLASH, magneto resistive or magnetic RAM (“MRAM”), ferroelectric RAM (“FRAM”), holographic media, Ovonic/phase change, Nano crystals, Nanotube RAM (NRAM-Nantero), MEMS scanning probe systems, MEMS cantilever switch, polymer, molecular, nano-floating gate and single electron.

In an embodiment, at least portions of control 102a, point 102b, photo/video application 102c and images 102d are stored in memory, such as a hard disk drive. When computing device 1800 is powered on, various portions of control 102a, point 102b, photo/video application 102c and images 102d are loaded into RAM for execution by processor(s) 1802. In embodiments other applications can be stored on the hard disk drive for execution by processor(s) 1802.

The above described computing device 1800 is just one example of a computing device 101, image capture device 104 and eye tracker 105 discussed above with reference to FIG. 1 and various other Figures. As was explained above, there are various other types of computing devices with which embodiments described herein can be used.

The flowcharts and block diagrams in the Figures illustrate the architecture, functionality, and operation of possible implementations of systems (apparatus), methods and a computer (software) programs, according to embodiments. In this regard, each block in the flowchart or block diagram may represent a software component. It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and software components.

In embodiments, illustrated and/or described signal paths are media that transfers a signal, such as an interconnect, conducting element, contact, pin, region in a semiconductor substrate, wire, metal trace/signal line, or photoelectric conductor, singly or in combination. In an embodiment, multiple signal paths may replace a single signal path illustrated in the figures and a single signal path may replace multiple signal paths illustrated in the figures. In embodiments, a signal path may include a bus and/or point-to-point connection. In an embodiment, a signal path includes control and data signal lines. In still other embodiments, signal paths are unidirectional (signals that travel in one direction) or bidirectional (signals that travel in two directions) or combinations of both unidirectional signal lines and bidirectional signal lines.

The foregoing detailed description has been presented for purposes of illustration and description. It is not intended to be exhaustive or to limit the inventive system to the precise form disclosed. Many modifications and variations are possible in light of the above teaching. As used herein, the singular forms “a”, “an” and “the” are intended to include the plural forms as well, unless the context clearly indicates otherwise. The described embodiments were chosen in order to best explain the principles of the inventive system and its practical application to thereby enable others skilled in the art to best utilize the inventive system in various embodiments and with various modifications as are suited to the particular use contemplated. It is intended that the scope of the inventive system be defined by the claims appended hereto.

What is claimed is:

1. A method of obtaining an image, the method comprising:
receiving information that indicates a direction of a gaze in a view finder;
determining a point of interest in the view finder based on the information that indicates the direction of the gaze;
determining an amount of exposure to capture the image based on the point of interest;
adjusting a field of view in the view finder about the point of interest; and
capturing the image with the amount of exposure and field of view.

2. The method of claim 1, wherein the information that indicates the direction of the gaze includes a gaze vector, wherein the gaze vector is received from an eye tracker.

3. The method of claim 2, wherein adjusting the field of view includes digitally zooming in about the point of interest.

4. The method of claim 3, wherein determining the amount of exposure includes determining a quantity of light to reach a sensor to capture the image, wherein the amount of exposure is measured in lux seconds.

5. The method of claim 4, wherein the image is included in one of a photograph and a video.

6. The method of claim 5, further comprising storing the image with the amount of exposure and field of view in processor readable memory.

7. The method of claim 6, wherein the view finder includes a display and the method of claim 6 further comprising:
retrieving the image with the amount of exposure and field of view in the processor readable memory; and
providing the image with the amount of exposure and field of view on the display.

8. The method of claim 7, wherein the eye tracker, view finder, sensor and processor readable memory are packaged in one of a camera, tablet, telephone and glasses.

9. The method of claim 1, wherein the information that indicates the direction of the gaze is received from an eye tracker, wherein determining the amount of exposure includes determining a quantity of light to reach a sensor to capture the image, further comprising:
storing the image with the amount of exposure and field of view in processor readable memory;
retrieving the image with the amount of exposure and field of view in the processor readable memory; and
providing the image with the amount of exposure and field of view on the view finder.

10. The method of claim 1, further comprising:
performing image enhancing effects on the image with the amount of exposure and field of view based on the point of interest.

11. An apparatus comprising;
a view finder;
at least one sensor to capture an image in the view finder in response to a first signal that indicates an amount of exposure and a second signal that indicates a point to zoom from in the view finder;
at least one eye tracker to output a gaze vector that indicates a direction of a gaze in the view finder;
at least one processor; and
at least one processor readable memory to store processor readable instructions,
wherein the at least one processor executes the processor readable instructions to:
receive the gaze vector;
determine a point of interest in the view finder based on the gaze vector;
determine an amount of exposure based on the point of interest;
determine the point to zoom from in the view finder; and
output the first signal that indicates the amount of exposure and the second signal that indicates the point to zoom from in the view finder, wherein the point to zoom from is the point of interest.

12. The apparatus of claim 11, wherein apparatus includes glasses and the view finder is projected on a lens of the glasses.

13. The apparatus of claim 11, wherein the apparatus includes a cellular telephone and the view finder is provided on a touch screen of the cellular telephone.

14. The apparatus of claim 11, wherein the at least one processor executes the processor readable instructions to:
store the image in the at least one processor readable memory; and
retrieve the image from the at least one processor readable memory to be viewed on the view finder.

15. The apparatus of claim 11, wherein the at least one processor executes the processor readable instructions to:
perform image enhancing effects on the image based on the point of interest.

16. One or more processor readable memories having instructions encoded thereon which when executed cause one or more processors to perform a method for capturing an image by a camera, the method comprising:
receiving a gaze vector from an eye tracker;
determining a point of interest in a view finder of the camera based on the gaze vector;
determining an amount of exposure based on the point of interest;
determining a point to zoom from in the view finder;
outputting a first signal that indicates the amount of exposure to the camera; and
outputting a second signal that indicates the point to zoom from in the view finder to the camera, wherein the point to zoom from is the point of interest.

17. The one or more processor readable memories of claim 16, the method further comprising:
receiving the image from the camera;
storing the image in the one or more processor readable memories; and
retrieving the image from the one or more processor readable memories to be displayed on the view finder.

18. The one or more processor readable memories of claim 17, the method further comprising:
performing image enhancing effects on the image based on the point of interest.

19. The one or more processor readable memories of claim 16, the method further comprising:
outputting a third signal that indicates an amount of zoom around the point of interest.

20. The one or more processor readable memories of claim 16, wherein determining the amount of exposure includes determining a quantity of light to reach a sensor in the camera, wherein the amount of exposure is measured in lux seconds.
